(19) United States
(12) Patent Application Publication
(10) Pub. No.: US 2022/0199099 A1
(43) Pub. Date: Jun. 23, 2022

(54) Audio Signal Processing Method and Related Product

(71) Applicant: Huawei Technologies Co., Ltd., Shenzhen (CN)

(72) Inventors: Chunjian Li, Shanghai (CN); Dong Shi, Shanghai (CN)

(21) Appl. No.: 17/605,121

(22) PCT Filed: Apr. 21, 2020
(86) PCT No.: PCT/CN2020/085800

§ 371 Date: Oct. 20, 2021

(30) Foreign Application Priority Data
Apr. 30, 2019 (CN) 201910369726.5

(51) Int. Cl. G10L 21/028; H04R 1/40; H04R 3/00; G10L 17/06; H04S 3/02

(52) U.S. Cl. CPC G10L 21/028; H04R 1/406; H04R 3/005; H04S 2400/15; H04S 3/02; H04R 2201/401; H04S 2400/01; G10L 17/06

(57) ABSTRACT

An audio signal processing method a includes receiving N channels of observed signals collected by a microphone array, and performing blind source separation on the N channels of observed signals to obtain M channels of source signals and M demixing matrices, where the M channels of source signals are in a one-to-one correspondence with the M demixing matrices, N is an integer greater than or equal to 2, and M is an integer greater than or equal to 1, obtaining a spatial characteristic matrix corresponding to the N channels of observed signals, where the spatial characteristic matrix is used to represent a correlation between the N channels of observed signals, obtaining a preset audio feature of each of the M channels of source signals, and determining, based on the preset audio feature of each channel of source signal, the M demixing matrices.

This application claims priority to Chinese Patent Application No. 201910369726.5, filed with the China National Intellectual Property Administration on Apr. 30, 2019 and entitled “AUDIO SIGNAL PROCESSING METHOD AND RELATED PRODUCT”, which is incorporated herein by reference in its entirety.

### TECHNICAL FIELD

This application relates to the field of audio signal processing technologies, and in particular, to an audio processing method and a related product.

### BACKGROUND

With the development of network and communications technologies, audio and video technologies, the network and communications technologies, and the like can be used to implement multi-party calls in complex acoustic environment scenarios. In many application scenarios, for example, in a large conference room, one party on a call involves a plurality of participants. To facilitate generation of a text and a conference summary in a later period, speaker diarization (English: speaker diarization) is usually performed on an audio signal to segment the entire audio signal into different segments and label speakers and the audio segments correspondingly. In this way, a speaker at each moment can be clearly known, and a conference summary can be quickly generated.

In a conventional technology, it is difficult to distinguish speakers with similar voices by using a single microphone-based speaker diarization technology; and it is difficult to distinguish speakers at angles close to each other by using a multi-microphone-based speaker diarization system, and the system is significantly affected by reverb in a room, and has low diarization accuracy. Therefore, the conventional technology has low speaker diarization accuracy.

### SUMMARY

Embodiments of this application provide an audio signal processing method, to improve speaker diarization accuracy to facilitate generation of a conference record, thereby improving user experience.

According to a first aspect, an embodiment of this application provides an audio signal processing method, including:

receiving N channels of observed signals collected by a microphone array, and performing blind source separation on the N channels of observed signals to obtain M channels of source signals and M demixing matrices, where the M channels of source signals are in a one-to-one correspondence with the M demixing matrices, N is an integer greater than or equal to 2, and M is an integer greater than or equal to 1;

obtaining a spatial characteristic matrix corresponding to the N channels of observed signals, where the spatial characteristic matrix is used to represent a correlation between the N channels of observed signals;

obtaining a preset audio feature of each of the M channels of source signals; and

determining, based on the preset audio feature of each channel of source signal, the M demixing matrices, and the spatial characteristic matrix, a speaker quantity and a speaker identity corresponding to the N channels of observed signals.

It can be learned that, the solution in this embodiment of this application is a speaker diarization technology based on a multi-microphone system, the spatial characteristic matrix and the preset audio feature are introduced, and speaker diarization can be implemented through speaker clustering by using the spatial characteristic matrix, the preset audio feature, and the demixing matrices, without knowing arrangement information of the microphone array in advance. In this way, a prior-art problem that diarization accuracy is reduced due to component aging is resolved. In addition, scenarios in which angles of speakers are close to each other and a speaker moves can be recognized due to the introduction of the audio feature, thereby further improving speaker diarization accuracy.

In some possible implementations, the obtaining a preset audio feature of each of the M channels of source signals includes: segmenting each of the M channels of source signals into Q audio frames, where Q is an integer greater than 1; and obtaining a preset audio feature of each audio frame of each channel of source signal. The source signal is segmented to help perform clustering subsequently by using the preset audio feature.

In some possible implementations, the obtaining a spatial characteristic matrix corresponding to the N channels of observed signals includes: segmenting each of the N channels of observed signals into Q audio frames; determining, based on N audio frames corresponding to each audio frame group, a spatial characteristic matrix corresponding to each first audio frame group, to obtain Q spatial characteristic matrices, where N audio frames corresponding to each first audio frame group are N audio frames of the N channels of observed signals in a same time window, and obtaining the spatial characteristic matrix corresponding to the N channels of observed signals based on the Q spatial characteristic matrices, where

$${c}^{F} ( k , n ) = \frac{{{X}^{F} ( k , n )}^{*} {X}^{FH} ( k , n )}{‖ {{X}^{F} ( k , n )}^{*} {X}^{FH} ( k , n ) ‖} ,$$

c^{F}(k,n) represents the spatial characteristic matrix corresponding to each first audio group, n represents frame sequence numbers of the Q audio frames, k represents a frequency index of an n^{th} audio frame, X^{F}(k,n) represents a column vector formed by a representation of a k^{th} frequency of an n^{th} audio frame of each channel of observed signal in frequency domain, X^{FH}(k,n) represents a transposition of X^{F}(k,n), n is an integer, and 1≤n≤Q. It can be learned that, because a spatial characteristic matrix reflects information about a position of a speaker relative to a microphone, a quantity of positions at which a speaker is located in a current scenario can be determined by introducing the spatial characteristic matrix, without knowing the arrangement information of the microphone array in advance.

In some possible implementations, the determining, based on the preset audio feature of each channel of source signal, the M demixing matrices, and the spatial characteristic matrix, a speaker quantity and a speaker identity corresponding to the N channels of observed signals includes: performing first clustering on the spatial characteristic matrix to obtain P initial clusters, where each initial cluster corresponds to one initial clustering center matrix, and the initial clustering center matrix is used to represent a spatial position of a speaker corresponding to each initial cluster, and P is an integer greater than or equal to 1; determining M similarities, where the M similarities are similarities between the initial clustering center matrix corresponding to each initial cluster and the M demixing matrices; determining, based on the M similarities, a source signal corresponding to each initial cluster; and performing second clustering on a preset audio feature of the source signal corresponding to each initial cluster, to obtain the speaker quantity and the speaker identity corresponding to the N channels of observed signals. It can be learned that, first clustering is performed first by using the spatial characteristic matrix to determine specific positions at which a speaker speaks in the current scenario, to obtain an estimated quantity of speakers; and then second clustering is performed by using the preset audio feature, to split or combine the initial clusters obtained through first clustering, to obtain an actual quantity of speakers in the current scenario. In this way, the speaker diarization accuracy is improved.

In some possible implementations, the determining, based on the M similarities, a source signal corresponding to each initial cluster includes: determining a maximum similarity in the M similarities; determining, as a target demixing matrix, a demixing matrix that is in the M demixing matrices and that is corresponding to the maximum similarity; and determining a source signal corresponding to the target demixing matrix as the source signal corresponding to each initial cluster. It can be learned that, first clustering is performed by using the spatial characteristic matrix, to determine specific positions at which a speaker speaks in the current scenario; and then a source signal corresponding to each speaker is determined by using similarities between the spatial characteristic matrix and the demixing matrices. In this way, the source signal corresponding to each speaker is quickly determined.

In some possible implementations, the performing second clustering on a preset audio feature of the source signal corresponding to each initial cluster, to obtain the speaker quantity and the speaker identity corresponding to the N channels of observed signals includes: performing second clustering on the preset audio feature of the source signal corresponding to each initial cluster, to obtain H target clusters, where the H target clusters represent the speaker quantity corresponding to the N channels of observed signals, each target cluster corresponds to one target clustering center, each target clustering center includes one preset audio feature and at least one initial clustering center matrix, a preset audio feature corresponding to each target cluster is used to represent a speaker identity of a speaker corresponding to the target cluster, and at least one initial clustering center matrix corresponding to each target cluster is used to represent a spatial position of the speaker. It can be learned that clustering is performed by using the preset audio features corresponding to each channel of source signal, and a splitting operation or a combination operation is performed on initial clusters corresponding to all the channels of source signals, to obtain target clusters corresponding to the M channels of source signals. Two channels of source signals separated because a speaker moves are combined into one target cluster, and two speakers at angles close to each other are split into two target clusters. In this way, the two speakers at angles close to each other are segmented, thereby improving the speaker diarization accuracy.

In some possible implementations, the method further includes: obtaining, based on the speaker quantity and the speaker identity corresponding to the N channels of observed signals, output audio including a speaker label. It can be learned that the audio signal is segmented based on the speaker identity and the speaker quantity that are obtained through clustering, and a speaker identity and a speaker quantity corresponding to each audio frame are determined. This facilitates generation of a conference summary in a conference room environment.

In some possible implementations, the obtaining, based on the speaker quantity and the speaker identity corresponding to the N channels of observed signals, output audio including a speaker label includes: determining K distances, where the K distances are distances between the spatial characteristic matrix corresponding to each first audio frame group and the at least one initial clustering center matrix corresponding to each target cluster, each first audio frame group includes N audio frames of the N channels of observed signals in a same time window, and K≥H; determining, based on the K distances, L target clusters corresponding to each first audio frame group, where L≤H; extracting, from the M channels of source signals, L audio frames corresponding to each first audio frame group, where a time window corresponding to the L audio frames is the same as a time window corresponding to the first audio frame group; determining L similarities, where the L similarities are similarities between a preset audio feature of each of the L audio frames and preset audio features corresponding to the L target clusters; determining, based on the L similarities, a target cluster corresponding to each of the L audio frames; and obtaining, based on the target cluster corresponding to each audio frame, the output audio including the speaker label, where the speaker label is used to indicate a speaker quantity and/or a speaker identity corresponding to each audio frame of the output audio. It can be learned that, the audio signal is segmented and labeled based on the speaker identity and the speaker quantity that are obtained through clustering, a speaker quantity corresponding to each audio frame group is first determined by using a spatial characteristic matrix, and then a source signal corresponding to each speaker is determined by using a preset audio feature of each audio frame of the source signal. In this way, the audio is segmented according to two steps and is labeled, thereby improving the speaker diarization accuracy.

In some possible implementations, the obtaining, based on the speaker quantity and the speaker identity corresponding to the N channels of observed signals, output audio including a speaker label includes: determining H similarities, where the H similarities are similarities between a preset audio feature of each audio frame in each second audio frame group and preset audio features of the H target clusters, and each second audio frame group includes audio frames of the M channels of source signals in a same time window; determining, based on the H similarities, a target cluster corresponding to each audio frame in each second audio frame group; and obtaining, based on the target cluster corresponding to each audio frame, the output audio including the speaker label, where the speaker label is used to indicate a speaker quantity and/or a speaker identity corresponding to each audio frame of the output audio. It can be learned that the audio is segmented and labeled directly by using an audio feature, thereby increasing a speaker diarization speed.

According to a second aspect, an embodiment of this application provides an audio processing apparatus, including:

an audio separation unit, configured to: receive N channels of observed signals collected by a microphone array, and perform blind source separation on the N channels of observed signals to obtain M channels of source signals and M demixing matrices, where the M channels of source signals are in a one-to-one correspondence with the M demixing matrices, N is an integer greater than or equal to 2, and M is an integer greater than or equal to 1;

a spatial feature extraction unit, configured to obtain a spatial characteristic matrix corresponding to the N channels of observed signals, where the spatial characteristic matrix is used to represent a correlation between the N channels of observed signals:

an audio feature extraction unit, configured to obtain a preset audio feature of each of the M channels of source signals; and

a determining unit, configured to determine, based on the preset audio feature of each channel of source signal, the M demixing matrices, and the spatial characteristic matrix, a speaker quantity and a speaker identity corresponding to the N channels of observed signals.

It can be learned that, the solution in this embodiment of this application is a speaker diarization technology based on a multi-microphone system, the spatial characteristic matrix and the preset audio feature are introduced, and speaker diarization can be implemented through speaker clustering by using the spatial characteristic matrix, the preset audio feature, and the demixing matrices, without knowing arrangement information of the microphone array in advance. In this way, a prior-art problem that diarization accuracy is reduced due to component aging is resolved. In addition, scenarios in which angles of speakers are close to each other and a speaker moves can be recognized due to the introduction of the audio feature, thereby further improving speaker diarization accuracy.

In some possible implementations, when obtaining the preset audio feature of each of the M channels of source signals, the audio feature extraction unit is specifically configured to: segment each of the M channels of source signals into Q audio frames, where Q is an integer greater than 1; and obtain a preset audio feature of each audio frame of each channel of source signal.

In some possible implementations, when obtaining the spatial characteristic matrix corresponding to the N channels of observed signals, the spatial feature extraction unit is specifically configured to: segment each of the N channels of observed signals into Q audio frames; determine, based on N audio frames corresponding to each audio frame group, a spatial characteristic matrix corresponding to each first audio frame group, to obtain Q spatial characteristic matrices, where N audio frames corresponding to each first audio frame group are N audio frames of the N channels of observed signals in a same time window; and obtain the spatial characteristic matrix corresponding to the N channels of observed signals based on the Q spatial characteristic matrices, where

$${c}^{F} ( k , n ) = \frac{{{X}^{F} ( k , n )}^{*} {X}^{FH} ( k , n )}{‖ {{X}^{F} ( k , n )}^{*} {X}^{FH} ( k , n ) ‖} ,$$

c^{F}(k,n) represents the spatial characteristic matrix corresponding to each first audio group, n represents frame sequence numbers of the Q audio frames, k represents a frequency index of an n^{th} audio frame, X^{F}(k,n) represents a column vector formed by a representation of a k^{th} frequency of an n^{th} audio frame of each channel of observed signal in frequency domain, X^{FH}(k,n) represents a transposition of X^{F}(k,n), n is an integer, and 1≤n≤Q.

In some possible implementations, when determining, based on the preset audio feature of each channel of source signal, the M demixing matrices, and the spatial characteristic matrix, the speaker quantity and the speaker identity corresponding to the N channels of observed signals, the determining unit is specifically configured to: perform first clustering on the spatial characteristic matrix to obtain P initial clusters, where each initial cluster corresponds to one initial clustering center matrix, and the initial clustering center matrix is used to represent a spatial position of a speaker corresponding to each initial cluster, and P is an integer greater than or equal to 1; determine M similarities, where the M similarities are similarities between the initial clustering center matrix corresponding to each initial cluster and the M demixing matrices; determine, based on the M similarities, a source signal corresponding to each initial cluster; and perform second clustering on a preset audio feature of the source signal corresponding to each initial cluster, to obtain the speaker quantity and the speaker identity corresponding to the N channels of observed signals.

In some possible implementations, when determining, based on the M similarities, the source signal corresponding to each initial cluster, the determining unit is specifically configured to: determine a maximum similarity in the M similarities; determine, as a target demixing matrix, a demixing matrix that is in the M demixing matrices and that is corresponding to the maximum similarity; and determine a source signal corresponding to the target demixing matrix as the source signal corresponding to each initial cluster.

In some possible implementations, when performing second clustering on the preset audio feature of the source signal corresponding to each initial cluster, to obtain the speaker quantity and the speaker identity corresponding to the N channels of observed signals, the determining unit is specifically configured to: perform second clustering on the preset audio feature of the source signal corresponding to each initial cluster, to obtain H target clusters, where the H target clusters represent the speaker quantity corresponding to the N channels of observed signals, each target cluster corresponds to one target clustering center, each target clustering center includes one preset audio feature and at least one initial clustering center matrix, a preset audio feature corresponding to each target cluster is used to represent a speaker identity of a speaker corresponding to the target cluster, and at least one initial clustering center matrix corresponding to each target cluster is used to represent a spatial position of the speaker.

In some possible implementations, the apparatus further includes an audio segmentation unit, where

the audio segmentation unit is configured to obtain, based on the speaker quantity and the speaker identity corresponding to the N channels of observed signals, output audio including a speaker label.

In some possible implementations, when obtaining, based on the speaker quantity and the speaker identity corresponding to the N channels of observed signals, the output audio including the speaker label, the audio segmentation unit is specifically configured to: determine K distances, where the K distances are distances between the spatial characteristic matrix corresponding to each first audio frame group and the at least one initial clustering center matrix corresponding to each target cluster, each first audio frame group includes N audio frames of the N channels of observed signals in a same time window, and K≥H; determine, based on the K distances, L target clusters corresponding to each first audio frame group, where L≤H; extract, from the M channels of source signals, L audio frames corresponding to each first audio frame group, where a time window corresponding to the L audio frames is the same as a time window corresponding to the first audio frame group; determine L similarities, where the L similarities are similarities between a preset audio feature of each of the L audio frames and preset audio features corresponding to the L target clusters; determine, based on the L similarities, a target cluster corresponding to each of the L audio frames; and obtain, based on the target cluster corresponding to each audio frame, the output audio including the speaker label, where the speaker label is used to indicate a speaker quantity and/or a speaker identity corresponding to each audio frame of the output audio.

In some possible implementations, when obtaining, based on the speaker quantity and the speaker identity corresponding to the N channels of observed signals, the output audio including the speaker label, the audio segmentation unit is specifically configured to: determine H similarities, where the H similarities are similarities between a preset audio feature of each audio frame in each second audio frame group and preset audio features of the H target clusters, and each second audio frame group includes audio frames of the M channels of source signals in a same time window; determine, based on the H similarities, a target cluster corresponding to each audio frame in each second audio frame group; and obtain, based on the target cluster corresponding to each audio frame, the output audio including the speaker label, where the speaker label is used to indicate a speaker quantity and/or a speaker identity corresponding to each audio frame of the output audio.

According to a third aspect, an embodiment of this application provides an audio processing apparatus, including:

a processor, a communications interface, and a memory that are coupled to each other, where

the communications interface is configured to receive N channels of observed signals collected by a microphone array, where N is an integer greater than or equal to 2; and

the processor is configured to: perform blind source separation on the N channels of observed signals to obtain M channels of source signals and M demixing matrices, where the M channels of source signals are in a one-to-one correspondence with the M demixing matrices, and M is an integer greater than or equal to 1; obtain a spatial characteristic matrix corresponding to the N channels of observed signals, where the spatial characteristic matrix is used to represent a correlation between the N channels of observed signals; obtain a preset audio feature of each of the M channels of source signals; and determine, based on the preset audio feature of each channel of source signal, the M demixing matrices, and the spatial characteristic matrix, a speaker quantity and a speaker identity corresponding to the N channels of observed signals.

According to a fourth aspect, an embodiment of this application further provides a computer-readable storage medium. The computer-readable storage medium stores a computer program. The computer program is executed by hardware (for example, a processor), to implement some or all of steps of any method performed by an audio processing apparatus in the embodiments of this application.

According to a fifth aspect, an embodiment of this application provides a computer program product including instructions. When the computer program product runs on an audio processing apparatus, the audio processing apparatus is enabled to perform some or all of the steps of the audio signal processing method in the foregoing aspects.

### BRIEF DESCRIPTION OF DRAWINGS

FIG. 1A is a schematic flowchart according to an embodiment of this application;

FIG. 1B is a schematic flowchart of an audio signal processing method according to an embodiment of this application;

FIG. 2A is a schematic flowchart of another audio signal processing method according to an embodiment of this application;

FIG. 2B is a schematic diagram of a frequency representation in frequency domain according to an embodiment of this application;

FIG. 2C is a schematic diagram of a speaking scenario according to an embodiment of this application;

FIG. 2D is a schematic diagram of another speaking scenario according to an embodiment of this application;

FIG. 3 is a schematic flowchart of another audio signal processing method according to an embodiment of this application;

FIG. 4 is a schematic flowchart of another audio signal processing method according to an embodiment of this application;

FIG. 5A is a schematic diagram of displaying output audio in an interface according to an embodiment of this application;

FIG. 5B is another schematic diagram of displaying output audio in an interface according to an embodiment of this application:

FIG. 5C is another schematic diagram of displaying output audio in an interface according to an embodiment of this application:

FIG. 6 is a schematic diagram of an audio processing apparatus according to an embodiment of this application; and

FIG. 7 is a schematic diagram of an audio processing apparatus according to an embodiment of this application.

### DESCRIPTION OF EMBODIMENTS

In the specification, claims, and accompanying drawings of this application, the terms “first”, “second”, “third”, “fourth”, and the like are intended to distinguish between different objects but are not intended to describe a specific order. Moreover, the terms “include”, “have”, and any variants thereof mean to cover the non-exclusive inclusion. For example, a process, method, system, product, or device that includes a list of steps or units is not limited to steps or units expressly listed, but may optionally further include steps or units not expressly listed, or optionally further include other steps or units inherent to such a process, method, product, or device.

“An embodiment” mentioned in this specification means that a specific feature, result, or characteristic described with reference to this embodiment may be included in at least one embodiment of this application. The expression at various positions in this specification does not necessarily mean a same embodiment, and is not an independent or alternative embodiment mutually exclusive with other embodiments. It is understood explicitly and implicitly by a person skilled in the art that the embodiments described in this specification may be combined with other embodiments.

The following first describes a blind source separation BSS (blind source separation, BSS) technology.

The BSS technology is mainly used to resolve a “cocktail party” problem, that is, used to separate, from a given mixed signal, an independent signal generated when each person speaks. When there are M source signals, it is usually assumed that there are also M observed signals, or in other words, it is assumed that there are M microphones in a microphone array. For example, two microphones are placed at different positions in a room, two persons speak at the same time, and each microphone can collect audio signals generated when the two persons speak, and output one channel of observed signal. Assuming that two observed signals output by the two microphones are x₁ and x₂, and the two channels of source signals are s₁ and s₂, x₁ and x₂ each are formed by mixing s₁ and s₂. To be specific, x₁=a₁₁*s₁+a₁₂*s₂, and x₂=a₂₁*s₁+a₂₂*s₂. The BSS technology is mainly used to resolve how to separate s₁ and s₂ from x₁ and x₂.

When there are M channels of observed signals x₁, . . . , and x_{M}, the BSS technology is mainly used to resolve how to separate M channels of source signals s₁, . . . , and s_{M} from x₁, . . . , and x_{M}. It can be learned from the foregoing example that X=AS, X=[x₁, . . . , x_{M}], and S=[s₁, . . . , s_{M}], and A represents a hybrid matrix. It is assumed that Y=WX, where Y represents an estimate of S, W represents a demixing matrix, and W is obtained by using a natural gradient method. Therefore, during BSS, the demixing matrix W is first obtained, and then separation is performed on the observed signal X by using the demixing matrix W, to obtain the source signal S, where the demixing matrix W is obtained by using the natural gradient method.

In a conventional technology, during single microphone-based speaker diarization, diarization is performed by mainly using audio features of speakers, and diarization on speakers with similar voices (speakers whose audio features are similar) cannot be implemented, leading to low diarization accuracy. A multi-microphone-based speaker diarization system needs to obtain angles and positions of speakers, and perform speaker diarization by using the angles and the positions of the speakers. Therefore, the multi-microphone-based speaker diarization system needs to know arrangement information and spatial position information of a microphone array in advance. However, with the aging of a component, the arrangement information and the spatial position information of the microphone array change, and consequently diarization accuracy is reduced. In addition, it is difficult to distinguish speakers at angles close to each other through speaker diarization by using the angles and positions of the speakers, and the diarization is significantly affected by reverb in a room, leading to low diarization accuracy. To resolve a prior-art problem of low speaker diarization accuracy, an audio signal processing method in this application is specially provided to improve speaker diarization accuracy.

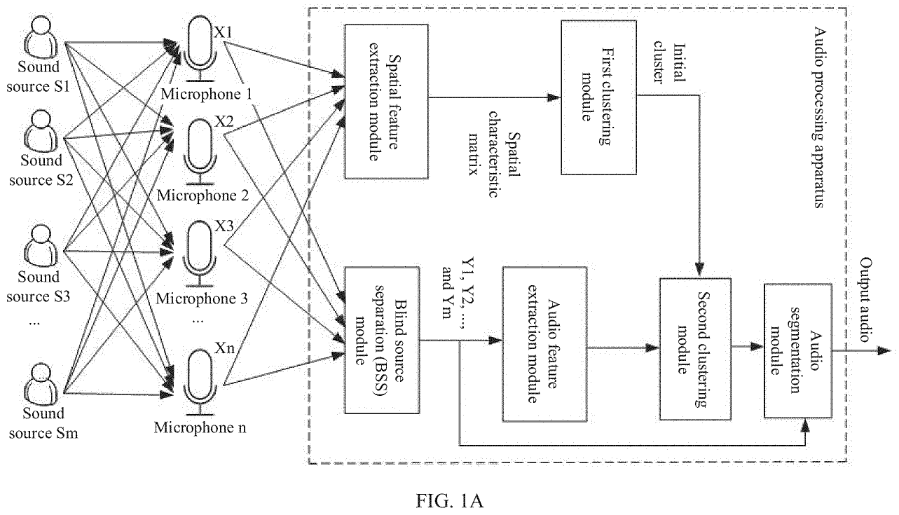

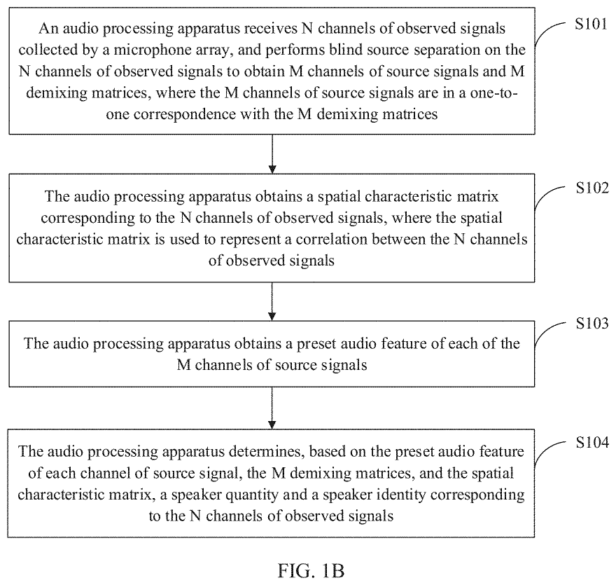

FIG. 1A is a scenario architecture diagram of an audio signal processing method. The scenario architecture diagram includes a sound source, a microphone array, and an audio processing apparatus. The audio processing apparatus includes a spatial feature extraction module, a blind source separation module, an audio feature extraction module, a first clustering module, a second clustering module, and an audio segmentation module. The microphone array is configured to collect speech audio of a speaker to obtain an observed signal. The spatial feature extraction module is configured to determine a spatial characteristic matrix corresponding to the observed signal. The blind source separation module is configured to perform blind source separation on the observed signal to obtain a source signal. The first clustering module is configured to perform first clustering on the spatial characteristic matrix to obtain an initial cluster. The audio feature extraction module is configured to perform feature extraction on the source signal to obtain a preset audio feature corresponding to the source signal. The second clustering module is configured to perform second clustering based on the preset audio feature corresponding to the source signal and the initial cluster, to obtain a target cluster. The audio segmentation module is configured to perform audio segmentation on the source signal based on the target cluster, and output an audio signal and a speaker label, where the speaker label is used to indicate a speaker quantity and/or a speaker identity corresponding to each audio frame of the output audio signal.

It can be learned that, a solution in this embodiment of this application is a speaker diarization technology based on a multi-microphone system, a spatial characteristic matrix and a preset audio feature are introduced, and speaker diarization can be implemented through speaker clustering by using the spatial characteristic matrix, the preset audio feature, and a demixing matrix, without knowing arrangement information of the microphone array in advance. In this way, a prior-art problem that diarization accuracy is reduced due to component aging is resolved. In addition, scenarios in which angles of speakers are close to each other and a speaker moves can be recognized due to the introduction of the audio feature, thereby further improving speaker diarization accuracy.

The technical solution in this embodiment of this application may be specifically implemented based on the scenario architecture diagram shown in FIG. 1A as an example.

FIG. 1B is a schematic flowchart of an audio signal processing method according to an embodiment of this application. The method may include but is not limited to the following steps.

Step 101: An audio processing apparatus receives N channels of observed signals collected by a microphone array, and performs blind source separation on the N channels of observed signals to obtain M channels of source signals and M demixing matrices, where the M channels of source signals are in a one-to-one correspondence with the M demixing matrices. N is an integer greater than or equal to 2, and M is an integer greater than or equal to 1.

Methods for performing blind source separation on the N channels of observed signals include a time domain separation method and a frequency domain separation method.

Step 102: The audio processing apparatus obtains a spatial characteristic matrix corresponding to the N channels of observed signals, where the spatial characteristic matrix is used to represent a correlation between the N channels of observed signals.

The correlation between the N channels of observed signals is caused because spatial positions of a speaker relative to microphones are different, or in other words, the spatial characteristic matrix reflects spatial position information of the speaker.

Step 103: The audio processing apparatus obtains a preset audio feature of each of the M channels of source signals.

The preset audio feature includes but is not limited to one or more of the following: a zero-crossing rate (ZCR), short-term energy, a fundamental frequency, and a mel-frequency cepstral coefficient (MFCC).

Step 104: The audio processing apparatus determines, based on the preset audio feature of each channel of source signal, the M demixing matrices, and the spatial characteristic matrix, a speaker quantity and a speaker identity corresponding to the N channels of observed signals.

It can be learned that, in this embodiment of this application, clustering is performed by using the preset audio feature, the demixing matrices, and the spatial characteristic matrix, to obtain the speaker identity and the speaker quantity. Compared with a conventional technology in which speaker diarization is performed by using only an audio feature, the solution in this embodiment of this application improves speaker diarization accuracy. In addition, in the multi-microphone-based speaker diarization technology in this application, speaker diarization can be performed by introducing the spatial characteristic matrix, without knowing arrangement information of the microphone array in advance, and a problem that diarization accuracy is reduced because the arrangement information changes due to component aging is resolved.

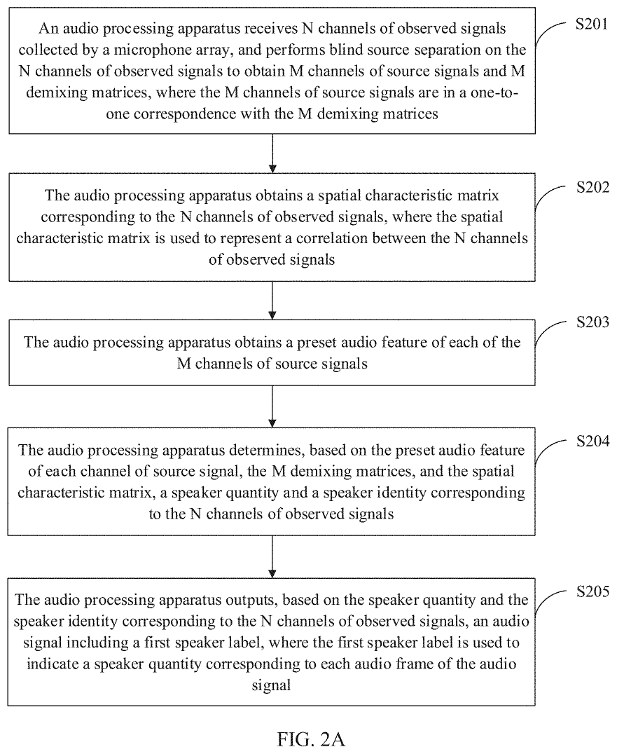

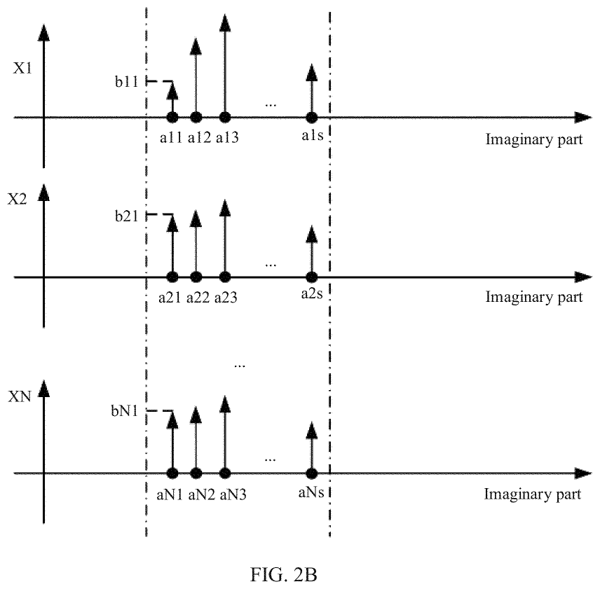

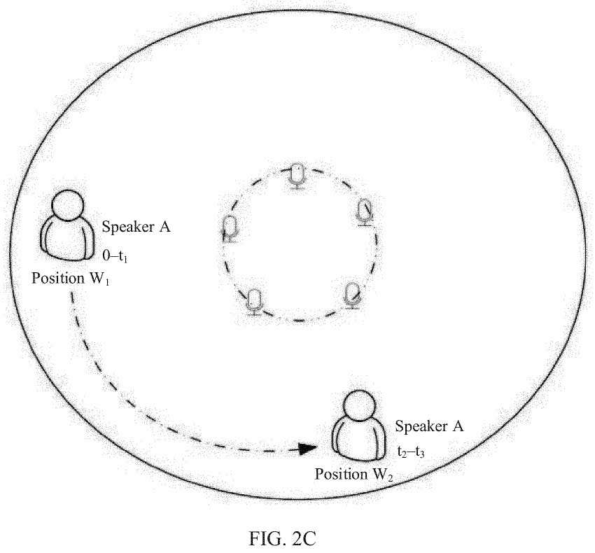

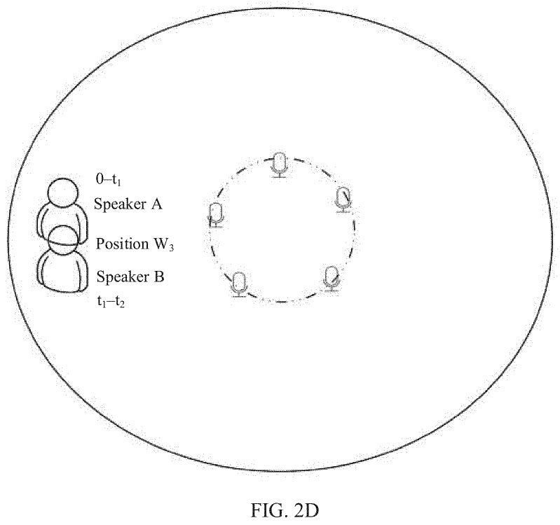

FIG. 2A is a schematic flowchart of another audio signal processing method according to an embodiment of this application. The method may include but is not limited to the following steps.

Step 201: An audio processing apparatus receives N channels of observed signals collected by a microphone array, and performs blind source separation on the N channels of observed signals to obtain M channels of source signals and M demixing matrices, where the M channels of source signals are in a one-to-one correspondence with the M demixing matrices, N is an integer greater than or equal to 2, and M is an integer greater than or equal to 1.

The N channels of observed signals are audio signals collected by the microphone array within a time period.

During blind source separation, for example, if there are D source signals, it is usually assumed that there are also D observed signals, to determine that a hybrid matrix is a square matrix. In this case, the microphone array is referred to as a standard independent component analysis (ICA) model. An ICA model used when a quantity of source signals is different from a quantity of dimensions of the microphone array is referred to as a non-square ICA (non-square ICA) model. In this application, a standard ICA model, that is, N=M, is used as an example for detailed description.

Optionally, performing blind source separation on the N channels of observed signals by using a time domain method specifically includes the following steps: It is assumed that the N channels of observed signals are respectively x₁, x₂, . . . , and x_{N}. An input signal X=[x₁, x₂, . . . , x_{N}] is formed by the N channels of observed signals. It is assumed that an output signal obtained after the BSS is Y, and Y=[s₁, s₂ . . . . , s_{M}]. It can be learned based on a BSS technology that Y=XW. W represents a matrix formed by the M demixing matrices. It is assumed that W=[w₁₁, w₁₂, . . . w_{1M}, w₂₁, w₂₂, . . . w_{2M}, . . . , w_{M1}, w_{M2}, . . . , w_{MM}], w of every M columns form one demixing matrix, and each demixing matrix is used to separate the N channels of observed signals to obtain one source signal. A separation formula for separating the M channels of source signals from the N channels of observed signals based on the BSS is as follows:

$${y}_{p} = {\sum }_{i = 1}^{N} {x}_{i} ⊗ {w}_{pi} ;$$

where
⊗

Optionally, when blind source separation is performed on the N channels of observed signals by using a frequency domain method, the foregoing separation formula is transformed to:

$${y}_{p}^{F} = {\sum }_{i = 1}^{N} {x}_{i}^{F} * {x}_{pi}^{F} ;$$

where

yₚ^{F}, xᵢ^{F}, and wₚᵢ^{F} represent an output signal, an input signal, and a demixing matrix in frequency domain, respectively.

Step 202: The audio processing apparatus obtains a spatial characteristic matrix corresponding to the N channels of observed signals, where the spatial characteristic matrix is used to represent a correlation between the N channels of observed signals.

Optionally, an implementation process of obtaining the spatial characteristic matrix corresponding to the N channels of observed signals may be: segmenting each of the N channels of observed signals into Q audio frames;

determining, based on N audio frames corresponding to each audio frame group, a spatial characteristic matrix corresponding to each first audio frame group, to obtain Q spatial characteristic matrices, where N audio frames corresponding to each first audio frame group are N audio frames of the N channels of observed signals in a same time window; and

obtaining the spatial characteristic matrix corresponding to the N channels of observed signals based on the Q spatial characteristic matrices, where

$${c}^{F} ( k , n ) = \frac{{{X}^{F} ( k , n )}^{*} {X}^{FH} ( k , n )}{‖ {{X}^{F} ( k , n )}^{*} {X}^{FH} ( k , n ) ‖} , where$$

$${c}^{F} ( k , n )$$

X^{F}(k,n) represents a column vector formed by a representation of a k^{th} X^{FH}(k,n) represents a transposition of X^{F}(k,n), n is an integer, 1≤n≤Q, and ∥X^{F}(k,n)*X^{FH}(k,n)∥ represents a norm of X^{FH}(k,n)*X^{F}(k,n).

A diagonal element in the spatial characteristic matrix represents energy of an observed signal collected by each microphone in the microphone array, and a non-diagonal element represents a correlation between observed signals collected by different microphones in the microphone array. For example, a diagonal element C₁₁ in the spatial characteristic matrix represents energy of an observed signal collected by the first microphone in the microphone array, and a non-diagonal element C₁₂ represents a correlation between observed signals collected by the first microphone and the second microphone in the microphone array. The correlation is caused because spatial positions of a speaker relative to the first microphone and the second microphone are different. Therefore, a spatial position of a speaker corresponding to each first audio frame group may be reflected by using a spatial characteristic matrix.

FIG. 2B is a schematic diagram of a representation of an audio frame of each of N channels of observed signals in any time window in frequency domain according to an embodiment of this application. Assuming that each audio frame corresponds to s frequencies, it can be seen from FIG. 2B that column vectors corresponding to all the first frequencies of the N channels of observed signals in the time window are [a₁₁+b₁₁*j, a₂₁+b₂₁*j, . . . , a_{N1}+b_{N1}*j]^{T}. N audio frames corresponding to each time window are used as one first audio frame group. Because each channel of observed signal is segmented into Q audio frames, Q first audio frame groups can be obtained. A representation that is of another frequency shown in FIG. 2B in the time window and that is in frequency domain is obtained, to obtain X^{FH}(k,n) corresponding to the first audio frame group in the time window:

$${X}^{FH} ( k , n ) = [ \begin{matrix}{a}_{11} + {b}_{11} * j & {a}_{12} + {b}_{12} * j & … & {a}_{1 s} + {b}_{1 s} * j \\ {a}_{21} + {b}_{21} * j & {a}_{22} + {b}_{22} * j & … & {a}_{2 s} + {b}_{2 s} * j \\ … & … & … & … \\ {a}_{N 1} + {b}_{N 1} * j & {a}_{N 2} + {b}_{N 2} * j & … & {a}_{Ns} + {b}_{N s} * j\end{matrix} ]$$

Based on the foregoing method for calculating a spatial characteristic matrix, the spatial characteristic matrix corresponding to each first audio group is calculated, to obtain the Q spatial characteristic matrices, and the Q spatial characteristic matrices are spliced according to a time sequence of time windows corresponding to the Q spatial characteristic matrices, to obtain the spatial characteristic matrix corresponding to the N channels of observed signals.

Step 203: The audio processing apparatus obtains a preset audio feature of each of the M channels of source signals.

Optionally, the step of obtaining a preset audio feature of each of the M channels of source signals includes: segmenting each of the M channels of source signals into Q audio frames, and obtaining a preset audio feature of each audio frame of each channel of source signal.

The preset audio feature includes but is not limited to one or more of the following: a zero-crossing rate (ZCR), short-term energy, a fundamental frequency, and a mel-frequency cepstral coefficient (MFCC).

The following details a process of obtaining the zero-crossing rate (ZCR) and the short-term energy.

$${Z}_{n} = \frac{1}{2} {\sum }_{m = 1}^{N} \vert sgn [ {x}_{n} ( m ) ] - sgn [ {x}_{n} ( m - 1 ) ] \vert ;$$

where

Zₙ represents a zero-crossing rate corresponding to an n^{th} audio frame of the Q audio frames, sgn[ ] represents a sign function, N represents a frame length of the n^{th} audio frame, and n represents a frame index of an audio frame.

$${E}_{n} = {\sum }_{m = 1}^{N} {x}_{n}^{2} ( m ) ;$$

Eₙ represents short-term energy of the n^{th} audio frame, and N represents the frame length of the n^{th} audio frame.

Step 204: The audio processing apparatus determines, based on the preset audio feature of each channel of source signal, the M demixing matrices, and the spatial characteristic matrix, a speaker quantity and a speaker identity corresponding to the N channels of observed signals.

First, first clustering is performed based on the spatial characteristic matrix to obtain P initial clusters, where each initial cluster corresponds to one initial clustering center matrix, and the initial clustering center matrix is used to represent a spatial position of a speaker corresponding to each initial cluster, and P is an integer greater than or equal to 1. M similarities are determined, where the M similarities are similarities between the initial clustering center matrix corresponding to each initial cluster and the M demixing matrices. A source signal corresponding to each initial cluster is determined based on the M similarities. Second clustering is performed on a preset audio feature of the source signal corresponding to each initial cluster, to obtain the speaker quantity and/or the speaker identity corresponding to the N channels of observed signals.

Specifically, because a spatial characteristic matrix reflects a spatial position of a speaker, the spatial characteristic matrix corresponding to each first audio group is used as sample data, and Q pieces of sample data are obtained. First clustering is performed by using the Q pieces of sample data, and spatial characteristic matrices between which a distance is less than a preset threshold are combined into one cluster to obtain one initial cluster. Each initial cluster corresponds to one initial clustering center matrix, the initial clustering center matrix represents a spatial position of a speaker, and an initial clustering center is represented in a form of a spatial characteristic matrix. After the clustering is completed, the P initial clusters are obtained, and it is determined that the N channels of observed signals are generated when a speaker speaks at P spatial positions.

Clustering algorithms that may be used for first clustering and second clustering include but are not limited to the following several types of algorithms: an expectation maximization (English: expectation maximization, EM) clustering algorithm, a K-means clustering algorithm, and a hierarchical agglomerative clustering (English: hierarchical agglomerative clustering, HAC) algorithm.

In some possible implementations, because a demixing matrix represents a spatial position, the demixing matrix reflects a speaker quantity to some extent. Therefore, when the K-means algorithm is used to perform first clustering, a quantity of initial clusters is estimated based on a quantity of demixing matrices. To be specific, a value of k in the K-means algorithm is set to the quantity M of demixing matrices, and then clustering centers corresponding to M initial clusters are preset to perform first clustering. In this way, the quantity of initial clusters is estimated by using the quantity of demixing matrices, thereby reducing a quantity of iterations and increasing a clustering speed.

Optionally, the step of determining, based on the M similarities, a source signal corresponding to each initial cluster includes: determining a maximum similarity in the M similarities; determining, as a target demixing matrix, a demixing matrix that is in the M demixing matrices and that is corresponding to the maximum similarity; and determining a source signal corresponding to the target demixing matrix as the source signal corresponding to each initial cluster. By calculating the similarities between the initial clustering center and the demixing matrices, a source signal corresponding to each of the P spatial positions is determined, or in other words, the source signal corresponding to each initial cluster is determined.

Optionally, an implementation process of performing second clustering on the preset audio feature of the source signal corresponding to each initial cluster, to obtain the speaker quantity and/or the speaker identity corresponding to the N channels of observed signals may be: performing second clustering on the preset audio feature of the source signal corresponding to each initial cluster, to obtain H target clusters, where the H target clusters represent the speaker quantity corresponding to the N channels of observed signals, each target cluster corresponds to one target clustering center, each target clustering center includes one preset audio feature and at least one initial clustering center matrix, a preset audio feature corresponding to each target cluster is used to represent a speaker identity of a speaker corresponding to the target cluster, and at least one initial clustering center matrix corresponding to each target cluster is used to represent a spatial position of the speaker.

Optionally, an implementation process of performing second clustering on the preset audio feature of the source signal corresponding to each initial cluster, to obtain H target clusters may be: performing second clustering on the preset audio feature of the source signal corresponding to each initial cluster, to obtain at least one target cluster corresponding to each initial cluster; and obtaining the H target clusters based on the at least one target cluster corresponding to each initial cluster.

Specifically, an eigenvector formed by a preset audio feature of each audio frame of the source signal corresponding to each initial cluster is used as one piece of sample data to obtain several pieces of sample data corresponding to the source signal corresponding to each initial cluster; and clustering is performed on the several pieces of sample data to combine sample data corresponding to similar audio features into one cluster to obtain a target cluster corresponding to the initial cluster. If the source signal corresponding to each initial cluster is an audio signal corresponding to one speaker, after a plurality of clustering iterations are performed, the several pieces of sample data correspond to one target clustering center. The target clustering center is represented in a form of an eigenvector, and the target clustering center represents identity information (an audio feature) of the speaker. If the source signal corresponding to each initial cluster corresponds to a plurality of speakers, after a plurality of clustering iterations are performed, the several pieces of sample data corresponding to the source signal corresponding to the initial cluster correspond to a plurality of target clustering centers. Each target clustering center represents identity information of each speaker. Therefore, the source signal corresponding to the initial cluster is split into a plurality of target clusters. If speakers corresponding to a first channel of source signal and a second channel of source signal are a same speaker, after second clustering is performed, target clustering centers corresponding to the two channels of source signals are a same target clustering center or clustering centers corresponding to the two channels of source signals are similar. In this case, two initial clusters corresponding to the two channels of source signals are combined into one target cluster. Because second clustering is performed based on first clustering, a target clustering center obtained through second clustering further includes a spatial position of a speaker obtained through first clustering.

For example, as shown in FIG. 2C, because a demixing matrix represents spatial position information of a speaker, each channel of source signal is separated based on a spatial position of a speaker. When one speaker speaks at different positions, during first clustering, a plurality of channels of source signals corresponding to the speaker are separated from an observed signal, and correspond to different initial clusters. For example, the speaker speaks at a position W₁ in a time period 0−t₁ and speaks at a position W₂ in a time period t₂−t₃, t₃>t₂>t₁, and it is determined that source signals corresponding to the speaker at W₁ and W₂ are s₁ and s₂, respectively. For example, s₁ corresponds to an initial cluster A, and s₂ corresponds to an initial cluster B. Because s₁ and s₂ correspond to a same speaker, and a preset audio feature in 0−t₁ is the same as that in t₂−t₃, after second clustering is performed, it may be determined that s₁ and s₂ correspond to a same target clustering center. Because t₂>t₁, it may be determined that s₂ is an audio signal generated when the speaker walks to the position W₂. Therefore, the two initial clusters A and B may be combined into one target cluster. In this case, the target clustering center corresponding to the target cluster includes the spatial positions W₁ and W₂ obtained through first clustering and the preset audio feature of the speaker obtained through second clustering.

For another example, as shown in FIG. 2D, if a speaker A and a speaker B speak at a same position W₃, because the positions of the speakers are the same, a channel of source signal s₃ corresponding to the position W₃ is separated based on a demixing matrix, but the source signal s₃ includes audio signals corresponding to the speaker A and the speaker B. Generally, the speaker A and the speaker B cannot keep speaking at the same position at the same time. It is assumed that the speaker A speaks but the speaker B does not speak at the position W₃ in a time period 0−t₁, and that the speaker B speaks at the position W₃ in a time period t₂−t₃. Because speakers who speak in the two time periods are different, preset audio features corresponding to the two time periods are different. In this case, after second clustering is performed, the channel of source signal corresponds to two target clustering centers. A first target clustering center includes the position information W₃ obtained through first clustering and an audio feature corresponding to the speaker A obtained through second clustering. A second target clustering center includes the position information W; obtained through first clustering and an audio feature corresponding to the speaker B obtained through second clustering.

Optionally, before the performing second clustering on a preset audio feature of the source signal corresponding to each initial cluster, the method further includes: performing human voice analysis on each channel of source signal to remove a source signal that is in the M channels of source signals and that is generated by a non-human voice. An implementation process of performing human voice analysis on each channel of source signal may be: comparing a preset audio feature of each audio frame of each channel of source signal with an audio feature of a human voice, to determine whether each channel of source signal includes a human voice.

Step 205: The audio processing apparatus outputs, based on the speaker quantity and the speaker identity corresponding to the N channels of observed signals, an audio signal including a first speaker label, where the first speaker label is used to indicate a speaker quantity corresponding to each audio frame of the audio signal.

Optionally, a step of obtaining, based on the speaker quantity and the speaker identity corresponding to the N channels of observed signals, the output audio including the first speaker label includes: determining K distances, where the K distances are distances between the spatial characteristic matrix corresponding to each first audio frame group and the at least one initial clustering center matrix corresponding to each target cluster, each first audio frame group includes N audio frames of the N channels of observed signals in a same time window, and K≥H; determining, based on the K distances, a speaker quantity corresponding to each first audio frame group, specifically including: determining L distances greater than a distance threshold in the H distances, and using L as the speaker quantity corresponding to the first audio frame group; then determining a time window corresponding to the first audio frame group, and marking a speaker quantity corresponding to an audio frame of the output audio in the time window as L; and finally sequentially determining speaker quantities corresponding to all the first audio frame groups, to obtain the first speaker label.

The distance threshold may be 80%, 90%, 95%, or another value.

Optionally, an audio frame of the output audio in each time window may include a plurality of channels of audio, or may be mixed audio of the plurality of channels of audio. For example, if a speaker A and a speaker B speak at the same time in 0−t₁, and the speaker A and the speaker B are at different spatial positions, first speech audio corresponding to the speaker A in 0−t₁ is extracted from a source signal corresponding to the speaker A, and similarly, second speech audio corresponding to the speaker B in 0−t₁ is extracted from a source signal corresponding to the speaker B. In this case, the first speech audio and the second speech audio may be retained separately, or in other words, the output audio corresponds to two channels of speech audio in 0−t₁; and in the output audio, a label indicates that two speakers speak at the same time in 0−t₁. Alternatively, the first speech audio and the second speech audio may be mixed, and in this case, the output audio corresponds to one channel of mixed audio in 0−t₁, and in the output audio, a label indicates that two speakers speak at the same time in 0−t₁.

It can be learned that, this embodiment of this application provides a speaker diarization method based on a multi-microphone system, the spatial characteristic matrix and the preset audio feature are introduced, and speaker diarization can be implemented through speaker determining by using the spatial characteristic matrix, the preset audio feature, and the demixing matrices, without knowing arrangement information of the microphone array in advance. In this way, a prior-art problem that diarization accuracy is reduced due to component aging is resolved. In addition, second clustering may be performed based on the audio feature to split one initial cluster corresponding to speakers at angles close to each other into two target clusters and combine two initial clusters generated because a speaker moves into one target cluster. This resolves a prior-art problem of low diarization accuracy.

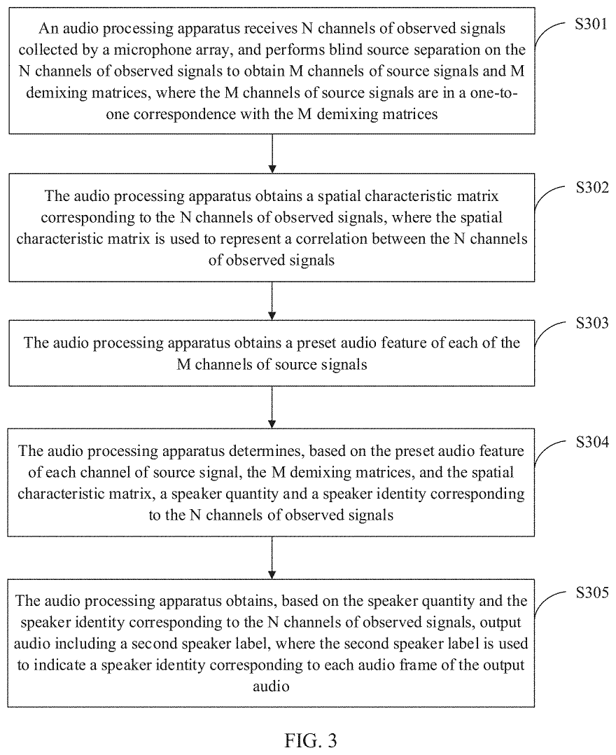

FIG. 3 is a schematic flowchart of an audio signal processing method according to an embodiment of this application. The method may include but is not limited to the following steps.

Step 301: An audio processing apparatus receives N channels of observed signals collected by a microphone array, and performs blind source separation on the N channels of observed signals to obtain M channels of source signals and M demixing matrices, where the M channels of source signals are in a one-to-one correspondence with the M demixing matrices, and both M and N are integers greater than or equal to 1.

Step 302: The audio processing apparatus obtains a spatial characteristic matrix corresponding to the N channels of observed signals, where the spatial characteristic matrix is used to represent a correlation between the N channels of observed signals.

Step 303: The audio processing apparatus obtains a preset audio feature of each of the M channels of source signals.

Step 304: The audio processing apparatus determines, based on the preset audio feature of each channel of source signal, the M demixing matrices, and the spatial characteristic matrix, a speaker quantity and a speaker identity corresponding to the N channels of observed signals.

Step 305: The audio processing apparatus obtains, based on the speaker quantity and the speaker identity corresponding to the N channels of observed signals, output audio including a second speaker label, where the second speaker label is used to indicate a speaker identity corresponding to each audio frame of the output audio.

Optionally, the step of obtaining, based on the speaker quantity and the speaker identity corresponding to the N channels of observed signals, output audio including a second speaker label includes: determining K distances, where the K distances are distances between a spatial characteristic matrix corresponding to each first audio frame group and at least one initial clustering center matrix corresponding to each target cluster, each first audio frame group includes N audio frames of the N channels of observed signals in a same time window, and K≥H; determining, based on the K distances, a speaker identity corresponding to each first audio frame group, specifically including: determining L distances greater than a distance threshold in the H distances (where L≤H), obtaining L target clusters corresponding to the L distances, and using the L target clusters as the speaker identity corresponding to the first audio frame group; then determining a time window corresponding to the first audio frame group, and determining that a speaker corresponding to the M channels of source signals in the time window is the L target clusters; and finally sequentially determining speaker quantities corresponding to all the audio frame groups, specifically including: determining a speaker quantity corresponding to the M channels of source signals in each time window, forming the output audio by using audio frames of the M channels of source signals in all the time windows, and determining the second speaker label based on a speaker identity corresponding to each time window, where the second speaker label is used to indicate the speaker identity corresponding to the output audio in each time window.

The distance threshold may be 80%, 90%, 95%, or another value.

Optionally, the audio frame of the output audio in each time window may include a plurality of channels of audio, or may be mixed audio of the plurality of channels of audio. For example, if a speaker A and a speaker B speak at the same time in 0−t₁, and the speaker A and the speaker B are at different spatial positions, first speech audio corresponding to the speaker A in 0−t₁ is extracted from a source signal corresponding to the speaker A. and similarly, second speech audio corresponding to the speaker B in 0−t₁ is extracted from a source signal corresponding to the speaker B. In this case, the first speech audio and the second speech audio may be retained separately, or in other words, the output audio corresponds to two channels of speech audio in 0−t₁; and in the output audio, the second speaker label is used to indicate that the speaker A and the speaker B speak at the same time in 0−t₁. Alternatively, the first speech audio and the second speech audio may be mixed, and in this case, the output audio corresponds to one channel of mixed audio in 0−t₁, and in the output audio, the second speaker label is used to indicate that the speaker A and the speaker B speak at the same time in 0−t₁.

It can be learned that, this embodiment of this application provides a speaker diarization method based on a multi-microphone system, the spatial characteristic matrix and the preset audio feature are introduced, and speaker diarization can be implemented through speaker determining by using the spatial characteristic matrix, the preset audio feature, and the demixing matrices, without knowing arrangement information of the microphone array in advance. In this way, a prior-art problem that diarization accuracy is reduced due to component aging is resolved. In addition, second clustering may be performed based on the audio feature to split one initial cluster corresponding to speakers at angles close to each other into two target clusters and combine two initial clusters generated because a speaker moves into one target cluster. This resolves a prior-art problem of low diarization accuracy.

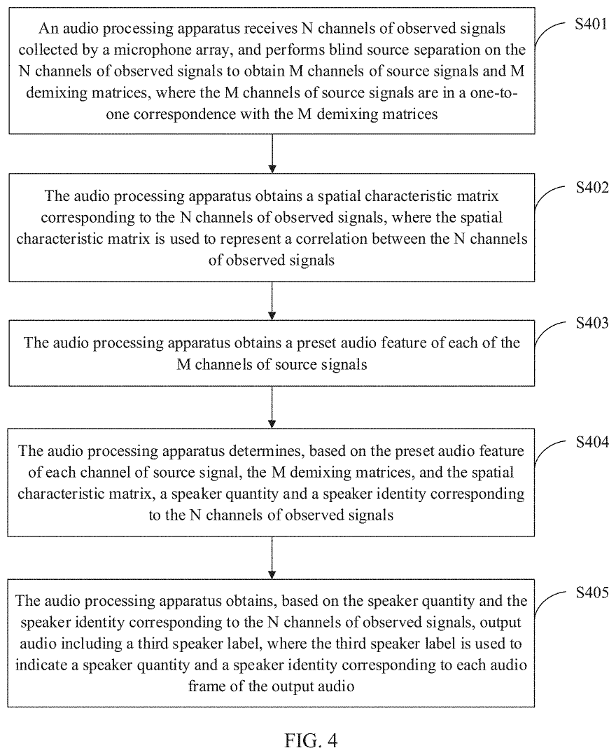

FIG. 4 is a schematic flowchart of an audio signal processing method according to an embodiment of this application. The method may include but is not limited to the following steps.

Step 401: An audio processing apparatus receives N channels of observed signals collected by a microphone array, and performs blind source separation on the N channels of observed signals to obtain M channels of source signals and M demixing matrices, where the M channels of source signals are in a one-to-one correspondence with the M demixing matrices, and both M and N are integers greater than or equal to 1.

Step 402: The audio processing apparatus obtains a spatial characteristic matrix corresponding to the N channels of observed signals, where the spatial characteristic matrix is used to represent a correlation between the N channels of observed signals.

Step 403: The audio processing apparatus obtains a preset audio feature of each of the M channels of source signals.

Step 404: The audio processing apparatus determines, based on the preset audio feature of each channel of source signal, the M demixing matrices, and the spatial characteristic matrix, a speaker quantity and a speaker identity corresponding to the N channels of observed signals.

Step 405: The audio processing apparatus obtains, based on the speaker quantity and the speaker identity corresponding to the N channels of observed signals, output audio including a third speaker label, where the third speaker label is used to indicate a speaker quantity and a speaker identity corresponding to each audio frame of the output audio.

Optionally, the step of obtaining, based on the speaker quantity and the speaker identity corresponding to the N channels of observed signals, output audio including a third speaker label includes: determining K distances, where the K distances are distances between a spatial characteristic matrix corresponding to each first audio frame group and at least one initial clustering center matrix corresponding to each target cluster, each first audio frame group includes N audio frames of the N channels of observed signals in a same time window, and K≥H; determining, based on the K distances, a speaker identity corresponding to each first audio frame group, specifically including: determining L distances greater than a distance threshold in the H distances (where L≤H), obtaining L target clusters corresponding to the L distances, and using the L target clusters as the speaker identity corresponding to the first audio frame group; then determining a time window corresponding to the first audio frame group, and determining that a speaker corresponding to the M channels of source signals in the time window is the L target clusters; extracting, from the M channels of source signals. L audio frames corresponding to each first audio frame group, where a time window corresponding to the L audio frames is the same as a time window corresponding to the first audio frame group; determining L similarities, where the L similarities are similarities between a preset audio feature of each of the L audio frames and preset audio features corresponding to the L target clusters; determining, based on the L similarities, a target cluster corresponding to each of the L audio frames, specifically including: using a target cluster corresponding to a maximum similarity in the L similarities as the target cluster corresponding to each audio frame, and then determining a speaker quantity corresponding to the time window and a source audio frame corresponding to each speaker; and finally obtaining, based on the target cluster corresponding to each audio frame, the output audio including the third speaker label. A speaker quantity corresponding to each time window is first determined by performing comparison based on spatial characteristic matrices, and then a speaker corresponding to each source audio frame is determined by performing comparison based on audio features of speakers, thereby improving speaker diarization accuracy.

The distance threshold may be 80%, 90%, 95%, or another value.

For example, if a speaker A and a speaker B speak at the same time in 0−t₁, and the speaker A and the speaker B are at different spatial positions, a corresponding target cluster A and target cluster B in 0−t₁ are determined by using a spatial characteristic matrix corresponding to a first audio group, and then two channels of source audio frames are extracted from the M channels of source signals in 0−t₁. However, which source audio frame corresponds to the speaker A and which source audio frame corresponds to the speaker B cannot be determined. Therefore, a preset audio feature of each of the two channels of source audio frames is compared with a preset audio feature corresponding to the target cluster A, to obtain a similarity. In this way, two similarities are obtained. A target cluster corresponding to the larger of the similarities is used as a speaker corresponding to each channel of source audio frame.

Optionally, the step of obtaining, based on the speaker quantity and the speaker identity corresponding to the N channels of observed signals, output audio including a third speaker label includes: determining H similarities, where the H similarities are similarities between a preset audio feature of each audio frame in each second audio frame group and preset audio features of the H target clusters, and each second audio frame group includes audio frames of the M channels of source signals in a same time window; determining, based on the H similarities, a target cluster corresponding to each audio frame in each second audio frame group; and obtaining, based on the target cluster corresponding to each audio frame, the output audio including the speaker label, where the speaker label is used to indicate a speaker quantity and/or a speaker identity corresponding to each audio frame of the output audio. Audio features are used to directly compare speakers, thereby increasing a speaker diarization speed.

For example, if a speaker A and a speaker B speak at the same time in 0−t₁, and the speaker A and the speaker B are at different spatial positions, two channels of corresponding source audio frames in 0−t₁ may be extracted from the M channels of source signals. However, which source audio frame corresponds to the speaker A and which source audio frame corresponds to the speaker B cannot be determined. Then, a preset audio feature of each of the two channels of source audio frames is directly compared with the H target clusters obtained after second clustering, and a target cluster corresponding to a largest similarity is used as a speaker corresponding to each channel of source audio frame.

Optionally, an audio frame of the output audio in each time window may include a plurality of channels of audio, or may be mixed audio of the plurality of channels of audio. For example, if a speaker A and a speaker B speak at the same time in 0−t₁, and the speaker A and the speaker B are at different spatial positions, first speech audio corresponding to the speaker A in 0−t₁ is extracted from a source signal corresponding to the speaker A, and similarly, second speech audio corresponding to the speaker B in 0−t₁ is extracted from a source signal corresponding to the speaker B. In this case, the first speech audio and the second speech audio may be retained separately, or in other words, the output audio corresponds to two channels of speech audio in 0−t₁; and in the output audio, the third speaker label is used to indicate that the speaker A and the speaker B speak at the same time in 0−t₁. Certainly, because a speaker corresponding to each channel of source audio frame is determined, when the audio corresponding to the speaker A and the speaker B is not mixed, a separate play button may be set. When a play button corresponding to the speaker A is clicked, the speech audio corresponding to the speaker A may be played separately. Alternatively, the first speech audio and the second speech audio may be mixed, and in this case, the output audio corresponds to one channel of mixed audio in 0−t₁, and in the output audio, the second speaker label is used to indicate that the speaker A and the speaker B speak at the same time in 0−t₁.

It can be learned that, this embodiment of this application provides a speaker diarization method based on a multi-microphone system, the spatial characteristic matrix and the preset audio feature are introduced, and speaker diarization can be implemented through speaker determining by using the spatial characteristic matrix, the preset audio feature, and the demixing matrices, without knowing arrangement information of the microphone array in advance. In this way, a prior-art problem that diarization accuracy is reduced due to component aging is resolved. In addition, second clustering may be performed based on the audio feature to split one initial cluster corresponding to speakers at angles close to each other into two target clusters and combine two initial clusters generated because a speaker moves into one target cluster. This resolves a prior-art problem of low diarization accuracy.

In some possible implementations, if the N channels of observed signals are audio signals obtained within a first preset time period, H clustering centers corresponding to the H target clusters corresponding to the N channels of observed signals are used in a next time window, and the H clustering centers are used as initial cluster values of observed signals obtained within a second preset time. In this way, parameter sharing is implemented within the two time periods, thereby increasing a clustering speed and improving speaker diarization efficiency.

In some possible implementations, based on the speaker diarization methods shown in FIG. 2A. FIG. 3, and FIG. 4, the output audio and the speaker label may be presented in an interface of an audio processing apparatus in the following several forms.

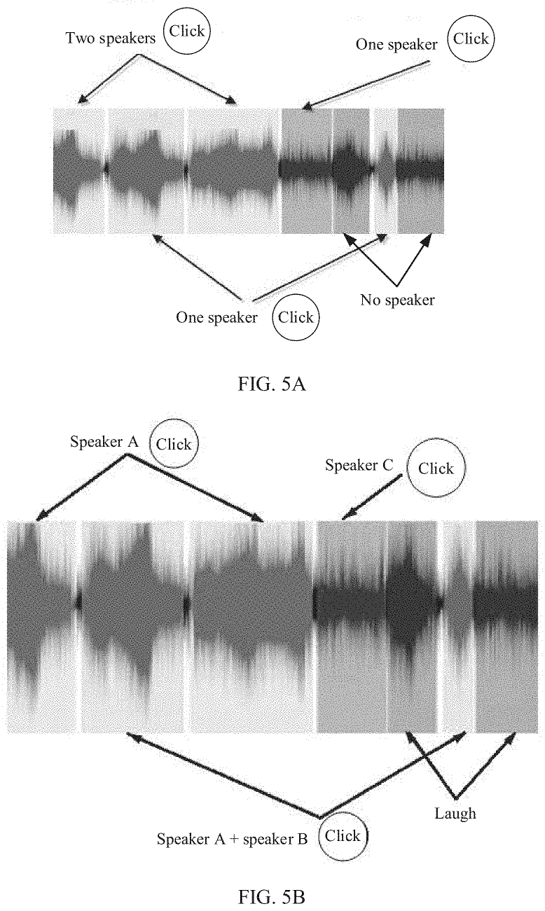

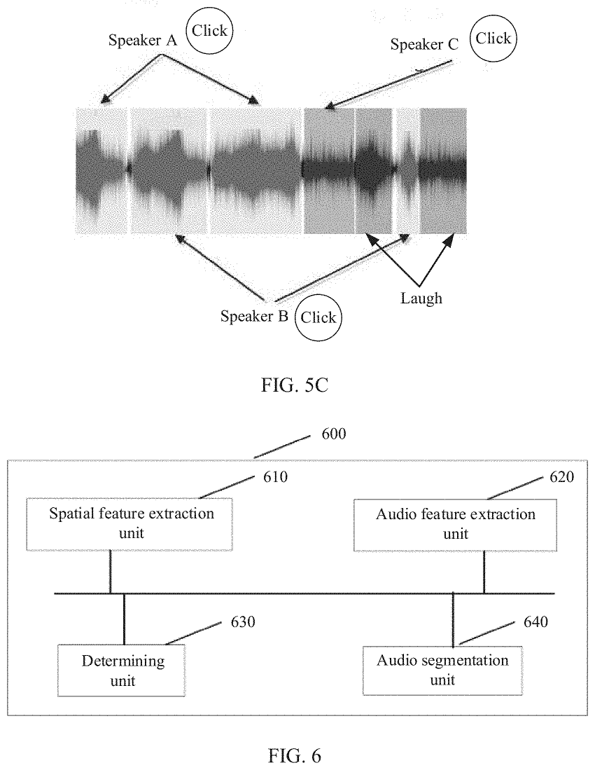

Optionally, FIG. 5A is a schematic diagram of displaying output audio in an interface according to an embodiment of this application. A display manner shown in FIG. 5A corresponds to the speaker diarization method in FIG. 2A. As shown in FIG. 5A, a first speaker label is added to each audio frame of output audio, and the first speaker label is used to indicate a speaker quantity corresponding to a time window. It can be understood that, if the output audio retains audio generated when each speaker speaks separately, or in other words, audio corresponding to speakers is not mixed for output, when the output audio corresponds to a plurality of speakers in a time window, independent audio signals corresponding to all the speakers in the time window may be successively played by clicking a “click” button next to the label. Certainly, during addition of the first speaker label, the first speaker label does not need to be added to the output audio, and the first speaker label and the output audio may be output in an associated manner. The first speaker label indicates a speaker quantity corresponding to each audio frame of the output audio, and the speaker quantity corresponding to each audio frame of the output audio may be determined by reading the first speaker label.

Optionally, FIG. 5B is another schematic diagram of displaying output audio in an interface according to an embodiment of this application. A display manner shown in FIG. 5B corresponds to the speaker diarization method in FIG. 3. During determining of a speaker identity corresponding to each audio frame of output audio, a second speaker label is added to an output audio frame to indicate a speaker identity corresponding to each time window. As shown in FIG. 5B, the second speaker label indicates that a speaker corresponding to the first audio frame and the third audio frame is a speaker A. It can be understood that, if the output audio retains audio generated when each speaker speaks separately, or in other words, audio corresponding to speakers is not mixed for output, when the output audio corresponds to a plurality of speakers in a time window, the audio corresponding to all the speakers is successively played by clicking a “click” button next to the label. However, a specific speaker to which an audio frame played each time belongs cannot be determined. Certainly, during addition of the second speaker label, the second speaker label does not need to be added to the output audio, and the second speaker label and the output audio may be output in an associated manner. The first speaker label indicates a speaker quantity corresponding to each audio frame of the output audio, and the speaker identity corresponding to each audio frame of the output audio may be determined by reading the second speaker label.

Optionally, FIG. 5C is another schematic diagram of displaying output audio in an interface according to an embodiment of this application. A display manner shown in FIG. 5C is corresponding to the speaker diarization method in FIG. 4. After a speaker quantity and a speaker identity corresponding to each audio frame of the output audio are determined, a third speaker label is added to the output audio to indicate a speaker quantity and a speaker identity corresponding to each time window. In addition, audio corresponding to speakers is not mixed in the output audio for output. When the output audio corresponds to a plurality of speakers in a time window, an identity of each speaker and a source signal corresponding to the speaker in the time window may be determined. All audio frames that are of the output audio and that are corresponding to each speaker can be determined by analyzing all the time windows of the output audio. Audio generated when each speaker speaks can be separately played by clicking a “click” button corresponding to each speaker, facilitating generation of a conference record. Certainly, during addition of the third speaker label, the third speaker label does not need to be added to the output audio, and the third speaker label and the output audio may be output in an associated manner. The speaker quantity and the speaker identity corresponding to the output audio in each time window are determined by reading the first speaker label.

Refer to FIG. 6. An embodiment of this application provides an audio processing apparatus 600. The apparatus 600 may include;

an audio separation unit 610, configured to: receive N channels of observed signals collected by a microphone array, and perform blind source separation on the N channels of observed signals to obtain M channels of source signals and M demixing matrices, where the M channels of source signals are in a one-to-one correspondence with the M demixing matrices, N is an integer greater than or equal to 2, and M is an integer greater than or equal to 1;

a spatial feature extraction unit 620, configured to obtain a spatial characteristic matrix corresponding to the N channels of observed signals, where the spatial characteristic matrix is used to represent a correlation between the N channels of observed signals;

an audio feature extraction unit 630, configured to obtain a preset audio feature of each of the M channels of source signals; and

a determining unit 640, configured to determine, based on the preset audio feature of each channel of source signal, the M demixing matrices, and the spatial characteristic matrix, a speaker quantity and a speaker identity corresponding to the N channels of observed signals.

It can be learned that, the solution in this embodiment of this application is a speaker diarization technology based on a multi-microphone system, the spatial characteristic matrix and the preset audio feature are introduced, and speaker diarization can be implemented through speaker clustering by using the spatial characteristic matrix, the preset audio feature, and the demixing matrices, without knowing arrangement information of the microphone array in advance. In this way, a prior-art problem that diarization accuracy is reduced due to component aging is resolved. In addition, scenarios in which angles of speakers are close to each other and a speaker moves can be recognized due to the introduction of the audio feature, thereby further improving speaker diarization accuracy.

In some possible implementations, when obtaining the preset audio feature of each of the M channels of source signals, the audio feature extraction unit 630 is specifically configured to: segment each of the M channels of source signals into Q audio frames, where Q is an integer greater than 1; and obtain a preset audio feature of each audio frame of each channel of source signal.

In some possible implementations, when obtaining the spatial characteristic matrix corresponding to the N channels of observed signals, the spatial feature extraction unit 620 is specifically configured to: segment each of the N channels of observed signals into Q audio frames; determine, based on N audio frames corresponding to each audio frame group, a spatial characteristic matrix corresponding to each first audio frame group, to obtain Q spatial characteristic matrices, where N audio frames corresponding to each first audio frame group are N audio frames of the N channels of observed signals in a same time window; and obtain the spatial characteristic matrix corresponding to the N channels of observed signals based on the Q spatial characteristic matrices, where

$${c}^{F} ( k , n ) = \frac{{X}^{F} ( k , n ) * {X}^{FH} ( k , n )}{‖ {X}^{F} ( k , n ) * {X}^{FH} ( k , n ) ‖} ,$$

c^{F}(k,n) represents the spatial characteristic matrix corresponding to each first audio group, n represents frame sequence numbers of the Q audio frames, k represents a frequency index of an n^{th} audio frame, X^{F}(k,n) represents a column vector formed by a representation of a k^{th} frequency of an n^{th} audio frame of each channel of observed signal in frequency domain, X^{FH}(k,n) represents a transposition of X^{F}(k,n), n is an integer, and 1≤n≤Q.

In some possible implementations, when determining, based on the preset audio feature of each channel of source signal, the M demixing matrices, and the spatial characteristic matrix, the speaker quantity and the speaker identity corresponding to the N channels of observed signals, the determining unit 640 is specifically configured to: perform first clustering on the spatial characteristic matrix to obtain P initial clusters, where each initial cluster corresponds to one initial clustering center matrix, and the initial clustering center matrix is used to represent a spatial position of a speaker corresponding to each initial cluster, and P is an integer greater than or equal to 1; determine M similarities, where the M similarities are similarities between the initial clustering center matrix corresponding to each initial cluster and the M demixing matrices; determine, based on the M similarities, a source signal corresponding to each initial cluster; and perform second clustering on a preset audio feature of the source signal corresponding to each initial cluster, to obtain the speaker quantity and the speaker identity corresponding to the N channels of observed signals.

In some possible implementations, when determining, based on the M similarities, the source signal corresponding to each initial cluster, the determining unit is specifically configured to: determine a maximum similarity in the M similarities; determine, as a target demixing matrix, a demixing matrix that is in the M demixing matrices and that is corresponding to the maximum similarity; and determine a source signal corresponding to the target demixing matrix as the source signal corresponding to each initial cluster.

In some possible implementations, when performing second clustering on the preset audio feature of the source signal corresponding to each initial cluster, to obtain the speaker quantity and the speaker identity corresponding to the N channels of observed signals, the determining unit 640 is specifically configured to: perform second clustering on the preset audio feature of the source signal corresponding to each initial cluster, to obtain H target clusters, where the H target clusters represent the speaker quantity corresponding to the N channels of observed signals, each target cluster corresponds to one target clustering center, each target clustering center includes one preset audio feature and at least one initial clustering center matrix, a preset audio feature corresponding to each target cluster is used to represent a speaker identity of a speaker corresponding to the target cluster, and at least one initial clustering center matrix corresponding to each target cluster is used to represent a spatial position of the speaker.

In some possible implementations, the audio processing apparatus 100 further includes an audio segmentation unit 650, where

the audio segmentation unit 650 is configured to obtain, based on the speaker quantity and the speaker identity corresponding to the N channels of observed signals, output audio including a speaker label.

In some possible implementations, when obtaining, based on the speaker quantity and the speaker identity corresponding to the N channels of observed signals, the output audio including the speaker label, the audio segmentation unit 650 is specifically configured to: determine K distances, where the K distances are distances between the spatial characteristic matrix corresponding to each first audio frame group and the at least one initial clustering center matrix corresponding to each target cluster, each first audio frame group includes N audio frames of the N channels of observed signals in a same time window, and K≥H; determine, based on the K distances, L target clusters corresponding to each first audio frame group, where L≤H; extract, from the M channels of source signals, L audio frames corresponding to each first audio frame group, where a time window corresponding to the L audio frames is the same as a time window corresponding to the first audio frame group, determine L similarities, where the L similarities are similarities between a preset audio feature of each of the L audio frames and preset audio features corresponding to the L target clusters; determine, based on the L similarities, a target cluster corresponding to each of the L audio frames; and obtain, based on the target cluster corresponding to each audio frame, the output audio including the speaker label, where the speaker label is used to indicate a speaker quantity and/or a speaker identity corresponding to each audio frame of the output audio.

In some possible implementations, when obtaining, based on the speaker quantity and the speaker identity corresponding to the N channels of observed signals, the output audio including the speaker label, the audio segmentation unit 650 is specifically configured to: determine H similarities, where the H similarities are similarities between a preset audio feature of each audio frame in each second audio frame group and preset audio features of the H target clusters, and each second audio frame group includes audio frames of the M channels of source signals in a same time window; determine, based on the H similarities, a target cluster corresponding to each audio frame in each second audio frame group; and obtain, based on the target cluster corresponding to each audio frame, the output audio including the speaker label, where the speaker label is used to indicate a speaker quantity and/or a speaker identity corresponding to each audio frame of the output audio.

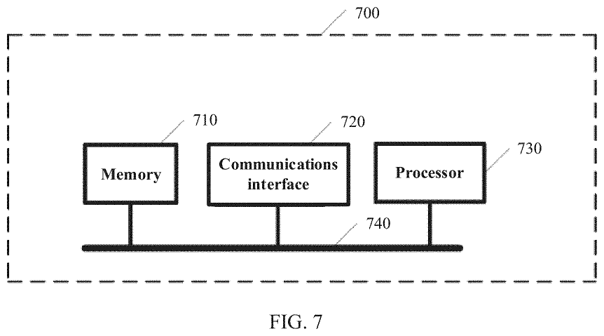

Refer to FIG. 7. An embodiment of this application provides an audio processing apparatus 700. The apparatus 700 includes:

a processor 730, a communications interface 720, and a memory 710 that are coupled to each other. For example, the processor 730, the communications interface 720, and the memory 710 are coupled to each other by using a bus 740.

The memory 710 may include but is not limited to a random access memory (random access memory, RAM), an erasable programmable read-only memory (erasable programmable ROM, EPROM), a read-only memory (read-only memory, ROM), a compact disc read-only memory (compact disc read-only memory, CD-ROM), and the like. The memory 810 is configured to store related instructions and data.

The processor 730 may be one or more central processing units (central processing units, CPUs). When the processor 730 is one CPU, the CPU may be a single-core CPU, or may be a multi-core CPU.

The processor 730 is configured to: read program code stored in the memory 710, and cooperate with the communications interface 740 in performing some or all of the steps of the methods performed by the audio processing apparatus in the foregoing embodiments of this application.

For example, the communications interface 720 is configured to receive N channels of observed signals collected by a microphone array, where N is an integer greater than or equal to 2.

The processor 730 is configured to: perform blind source separation on the N channels of observed signals to obtain M channels of source signals and M demixing matrices, where the M channels of source signals are in a one-to-one correspondence with the M demixing matrices, and M is an integer greater than or equal to 1; obtain a spatial characteristic matrix corresponding to the N channels of observed signals, where the spatial characteristic matrix is used to represent a correlation between the N channels of observed signals; obtain a preset audio feature of each of the M channels of source signals; and determine, based on the preset audio feature of each channel of source signal, the M demixing matrices, and the spatial characteristic matrix, a speaker quantity and a speaker identity corresponding to the N channels of observed signals.

It can be learned that, the solution in this embodiment of this application is a speaker diarization technology based on a multi-microphone system, the spatial characteristic matrix and the preset audio feature are introduced, and speaker diarization can be implemented through speaker clustering by using the spatial characteristic matrix, the preset audio feature, and the demixing matrices, without knowing arrangement information of the microphone array in advance. In this way, a prior-art problem that diarization accuracy is reduced due to component aging is resolved. In addition, scenarios in which angles of speakers are close to each other and a speaker moves can be recognized due to the introduction of the audio feature, thereby further improving speaker diarization accuracy.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedure or functions according to the embodiments of this application are completely or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, an optical disc), a semiconductor medium (for example, a solid-state drive), or the like. In the foregoing embodiments, the descriptions of the embodiments are emphasized differently. For a part that is not detailed in an embodiment, reference may be made to related descriptions of other embodiments.

An embodiment of this application further provides a computer-readable storage medium. The computer-readable storage medium stores a computer program, and the computer program is executed by related hardware to perform any audio signal processing method provided in the embodiments of this application. In addition, an embodiment of this application further provides a computer-readable storage medium. The computer-readable storage medium stores a computer program, and the computer program is executed by related hardware to perform any method provided in the embodiments of this application.

An embodiment of this application further provides a computer program product. When the computer program product runs on a computer, the computer is enabled to perform any audio signal processing method provided in the embodiments of this application. In addition, an embodiment of this application further provides a computer program product. When the computer program product runs on a computer, the computer is enabled to perform any method provided in the embodiments of this application.

In the foregoing embodiments, the descriptions of the embodiments are emphasized differently. For a part that is not detailed in an embodiment, reference may be made to related descriptions of other embodiments.

In several embodiments provided in this application, it should be understood that the disclosed apparatus may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual indirect couplings or direct couplings or communication connections may be implemented by using some interfaces. The indirect couplings or communication connections between the apparatuses or units may be implemented in electrical or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, function units in the embodiments of this application may be integrated into one processing unit, or each of the units may exist alone physically, or two or more units are integrated into one unit. The integrated unit may be implemented in a form of hardware, or may be implemented in a form of a software function unit.

If the integrated unit is implemented in the form of a software function unit and sold or used as an independent product, the integrated unit may be stored in a computer-readable storage medium Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of this application. The foregoing storage medium may include, for example, any medium that can store program code, such as a USB flash drive, a removable hard disk, a read-only memory (read-only memory, ROM), a random access memory (random access memory, RAM), a magnetic disk, or an optical disc.

1. A method comprising:
receiving N channels of observed signals from a microphone array, wherein N is an integer greater than or equal to two;
performing blind source separation on the N channels to obtain M channels of source signals and M demixing matrices, wherein the M channels are in a one-to-one correspondence with the M demixing matrices, and wherein M is an integer greater than or equal to one;
obtaining a first spatial characteristic matrix corresponding to the N channels, wherein the first spatial characteristic matrix represents a correlation among the N channels;
obtaining a first preset audio feature of each of the M channels; and
determining a first speaker quantity and a first speaker identity corresponding to the N channels based on the first preset audio feature of each of the M channels, the M demixing matrices, and the first spatial characteristic matrix.

2. The method of claim 1, further comprising:
segmenting each of the M channels into Q audio frames, wherein Q is an integer greater than one; and
obtaining a second preset audio feature of each audio frame of each of the M channels.

3. The method of claim 1, further comprising:
segmenting each of the N channels, wherein N audio frames in each of the N channels in a same time window defines a corresponding first audio frame group, into Q audio frames;
determining, based on N audio frames corresponding to each first audio frame group, a second spatial characteristic matrix corresponding to each first audio frame group to obtain Q spatial characteristic matrices; and
obtaining the first spatial characteristic matrix based on the Q spatial characteristic matrices, wherein
$${c}^{F} ( k , n ) = \frac{{X}^{F} ( k , n ) * {X}^{FH} ( k , n )}{‖ {X}^{F} ( k , n ) * {X}^{FH} ( k , n ) ‖} ,$$
wherein c^{F}(k,n) represents the second spatial characteristic matrix corresponding to each first audio frame group, wherein n represents frame sequence numbers of the Q audio frames, wherein k represents a frequency index of an n^{th} audio frame, wherein X^{F}(k,n) represents a column vector formed by a representation of a k^{th} frequency of the n^{th} audio frame of each of the N channels in a frequency domain, wherein X^{FH}(k,n) represents a transposition of X^{F}(k,n), wherein n is an integer, and wherein 1≤n≤Q.

4. The method of claim 1, further comprising:
performing first clustering on the first spatial characteristic matrix to obtain P initial clusters, wherein each of the P initial clusters corresponds to an initial clustering center matrix representing a first spatial position of a first speaker corresponding to a corresponding initial cluster, and wherein P is an integer greater than or equal to one;
determining M similarities among the initial clustering center matrix corresponding to each of the P initial clusters and the M demixing matrices;
determining, based on the M similarities, a first source signal corresponding to each of the P initial clusters; and
performing second clustering on a second preset audio feature of the first source signal to obtain the first speaker quantity and the first speaker identity.

5. The method of claim 4, further comprising:
determining a maximum similarity in the M similarities;
setting, as a target demixing matrix, a demixing matrix in the M demixing matrices corresponding to the maximum similarity; and
setting a second source signal corresponding to the target demixing matrix as the first source.

6. The method of claim 4, further comprising performing the second clustering on the second preset audio feature to obtain H target clusters, wherein the H target clusters represent the first speaker quantity, wherein each of the H target clusters corresponds to one target clustering center, wherein each target clustering center comprises one preset audio feature and at least one initial clustering center matrix, wherein a third preset audio feature corresponding to each of the H target cluster represents a second speaker identity of a second speaker corresponding to a corresponding target cluster, and wherein the at least one initial clustering center matrix corresponding to each of the H target clusters represents a second spatial position of the second speaker.

7. The method of claim 6, further comprising obtaining, based on the first speaker quantity and the first speaker identity, output audio comprising a speaker label.

8. The method of claim 7, wherein N audio frames in each of the N channels in a same time window defines a corresponding first audio frame group, the method further comprising:
determining K distances among a second spatial characteristic matrix corresponding to each first audio frame group and the at least one initial clustering center matrix, and wherein K≥H;
determining, based on the K distances, L target clusters corresponding to each first audio frame group, wherein L≤H;
extracting, from the M channels, L audio frames corresponding to each first audio frame group, wherein a first time window corresponding to the L audio frames is the same as a second time window corresponding to a corresponding first audio frame group;
determining L similarities among a fourth preset audio feature of each of the L audio frames and preset audio features corresponding to the L target clusters;
determining, based on the L similarities, a target cluster corresponding to each of the L audio frames; and
further obtaining, based on the target cluster, the output audio comprising the speaker label, wherein the speaker label indicates a second speaker quantity or a third speaker identity corresponding to each audio frame of the output audio.

9. The method of claim 7, wherein audio frames of the M channels in a same time window define second audio frame groups, and wherein the method further comprises:
determining H similarities among a fourth preset audio feature of each audio frame in each second audio frame group and preset audio features of the H target clusters;
determining, based on the H similarities, a target cluster corresponding to each audio frame in each second audio frame group; and
further obtaining, based on the target cluster, the output audio comprising the speaker label, wherein the speaker label indicates a second speaker quantity or a third speaker identity corresponding to each audio frame of the output audio.

10. An apparatus comprising:
a memory configured to store instructions; and
a processor coupled to the memory, wherein the instructions cause the processor to be configured to:
receive N channels of observed signals from a microphone array, wherein N is an integer greater than or equal to two;
perform blind source separation on the N channels to obtain M channels of source signals and M demixing matrices, wherein the M channels are in a one-to-one correspondence with the M demixing matrices, and wherein M is an integer greater than or equal to one;
obtain a first spatial characteristic matrix corresponding to the N channels, wherein the first spatial characteristic matrix represents a correlation among the N channels;
obtain a first preset audio feature of each of the M channels; and
a first speaker quantity and a first speaker identity corresponding to the N channels based on the first preset audio feature of each of the M channels, the M demixing matrices, and the first spatial characteristic matrix.

11. The apparatus of claim 10, wherein the instructions further cause the processor to be configured to:
segment each of the M channels into Q audio frames, wherein Q is an integer greater than one; and
obtain a second preset audio feature of each audio frame of each of the M channels.

12. The apparatus of claim 10, wherein N audio frames in each of the N channels in a same time window defines a corresponding first audio frame group, and wherein the instructions further cause the processor to be configured to:
segment each of the N channels into Q audio frames;
determine, based on N audio frames corresponding to each first audio frame group, a second spatial characteristic matrix corresponding to each first audio frame group to obtain Q spatial characteristic matrices; and
obtain the first spatial characteristic matrix based on the Q spatial characteristic matrices, wherein
$${c}^{F} ( k , n ) = \frac{{X}^{F} ( k , n ) * {X}^{FH} ( k , n )}{‖ {X}^{F} ( k , n ) * {X}^{FH} ( k , n ) ‖} ,$$
wherein c^{F}(k,n) represents the second spatial characteristic matrix corresponding to each first audio frame group, wherein n represents frame sequence numbers of the Q audio frames, wherein k represents a frequency index of an n^{th} audio frame, wherein X^{F}(k,n) represents a column vector formed by a representation of a k^{th} frequency of the n^{th} audio frame of each of the N channels in a frequency domain, wherein X^{FH}(k,n) represents a transposition of X^{F}(k,n), wherein n is an integer, and wherein 1≤n≤Q.

13. The apparatus of claim 10, wherein the instructions further cause the processor to be configured to:
perform first clustering on the first spatial characteristic matrix to obtain P initial clusters, wherein each of the P initial clusters corresponds to an initial clustering center matrix representing a first spatial position of a first speaker corresponding to a corresponding initial cluster, and wherein P is an integer greater than or equal to one;
determine M similarities, among the initial clustering center matrix corresponding to each of the P initial clusters and the M demixing matrices;
determine, based on the M similarities, a first source signal corresponding to each of the P initial clusters; and
perform second clustering on a second preset audio feature of the first source signal to obtain the first speaker quantity and the first speaker identity.

14. The apparatus of claim 13, wherein the instructions further cause the processor to be configured to:
determine a maximum similarity in the M similarities;
set, as a target demixing matrix, a demixing matrix in the M demixing matrices corresponding to the maximum similarity; and
set a second source signal corresponding to the target demixing matrix as the first source signal.

15. The apparatus of claim 13, wherein the instructions further cause the processor to be configured to further perform the second clustering on the second preset audio feature to obtain H target clusters, wherein the H target clusters represent the first speaker quantity, wherein each of the H target clusters corresponds to one target clustering center, wherein each target clustering center comprises one preset audio feature and at least one initial clustering center matrix, wherein a third preset audio feature corresponding to each of the H target cluster represents a second speaker identity of a second speaker corresponding to a corresponding target cluster, and wherein the at least one initial clustering center matrix corresponding to each of the H target clusters represents a second spatial position of the second speaker.

16. The apparatus of claim 15, wherein the instructions further cause the processor to be configured to obtain, based on the first speaker quantity and the first speaker identity, output audio comprising a speaker label.

17. The apparatus according to claim 16, wherein N audio frames in each of the N channels in a same time window defines a corresponding first audio frame group, and wherein the instructions further cause the processor to be configured to:
determine K distances among a second spatial characteristic matrix corresponding to each first audio frame group and the at least one initial clustering center matrix, and wherein K≥H;
determine, based on the K distances, L target clusters corresponding to each first audio frame group, wherein L≤H;
extract, from the M channels, L audio frames corresponding to each first audio frame group, wherein a first time window corresponding to the L audio frames is the same as a second time window corresponding to a corresponding first audio frame group;
determine L similarities among a fourth preset audio feature of each of the L audio frames and preset audio features corresponding to the L target clusters;
determine, based on the L similarities, a target cluster corresponding to each of the L audio frames; and
further obtain, based on the target cluster, the output audio comprising the speaker label, wherein the speaker label indicates a second speaker quantity or a third speaker identity corresponding to each audio frame of the output audio.

18. The apparatus according to claim 16, wherein audio frames in each of the M channels in a same time window defines a corresponding second audio frame group, and wherein the instructions further cause the processor to be configured to:
determine H similarities among a fourth preset audio feature of each audio frame in each second audio frame group and preset audio features of the H target clusters;
determine, based on the H similarities, a target cluster corresponding to each audio frame in each second audio frame group; and
further obtain, based on the target cluster, the output audio comprising the speaker label, wherein the speaker label indicates a second speaker quantity or a third speaker identity corresponding to each audio frame of the output audio.

19. (canceled)

20. A computer program product comprising computer-executable instructions that are stored on a non-transitory computer-readable medium and that, when executed by a processor, cause an apparatus to:
receive N channels of observed signals from a microphone array, wherein N is an integer greater than or equal to two;
perform blind source separation on the N channels to obtain M channels of source signals and M demixing matrices, wherein the M channels are in a one-to-one correspondence with the M demixing matrices, and wherein M is an integer greater than or equal to one;
obtain a first spatial characteristic matrix corresponding to the N channels, wherein the first spatial characteristic matrix represents a correlation among the N channels;
obtain a first preset audio feature of each of the M channels; and
determine a first speaker quantity and a first speaker identity corresponding to the N channels based on the first preset audio feature of each of the M channels, the M demixing matrices, and the first spatial characteristic matrix.

21. The computer program product of claim 20, wherein the computer-executable instructions further cause the apparatus to:
segment each of the M channels into Q audio frames, wherein Q is an integer greater than one; and
obtain a second preset audio feature of each audio frame of each of the M channels.
